(19) United States
(12) Patent Application Publication
(10) Pub. No.: US 2007/0194551 A1
(43) Pub. Date: Aug. 23, 2007

(54) VEHICLE SUSPENSION SYSTEM

(75) Inventors: Brendan Joseph Quill, Northampton (GB); Andrew John Ward, Northampton (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: HENDRICKSON USA, LLC, Itasca, IL (US)

(21) Appl. No.: 11/671,618

(22) Filed: Feb. 6, 2007

(30) Foreign Application Priority Data
Feb. 21, 2006 (GB) 0603400.3

(51) Int. Cl. B60G 11/27; B60G 9/00

(52) U.S. Cl. 280/124.157; 280/124.116

(57) ABSTRACT

A vehicle suspension system which includes a least one suspension airbag interposed between a vehicle axle and a vehicle body and a supplementary airbag positioned on a fixed support in the suspension system and extending to a structural member of the suspension system, the arrangement being such that with the suspension airbag inflated and the supplementary airbag deflated, the suspension system operates normally, and with the suspension airbag deflated and the supplementary airbag inflated, the suspension system is lifted with a consequent lifting of the axle, to bring its road wheels clear of the road surface.

### RELATED/PRIORITY APPLICATION

This application claims the benefit of British application Serial No. 0603400.3, filed Feb. 21, 2006.

### BACKGROUND OF THE INVENTION

This invention relates to vehicle suspension systems, and particularly to suspension systems employing airbags to support a vehicle, tractor unit or trailer unit on the axles to which the road wheels are attached. Such suspension systems are particularly effective in ensuring a comfortable ride of the passengers, and protecting any cargo that the vehicle may be carrying against excessive shocks transmitted from the road wheels through the suspension system and to the vehicle.

Axle/suspension systems for vehicles arguably are one of the most important structures of a vehicle, because they ensure a comfortable ride to the passengers in the vehicle and protect any cargo that the vehicle may be carrying from excessive shocks. Axle/suspension systems also provide stability to the vehicle by controlling various forces acting on the axle itself, which in turn could cause an unwanted change in position of the axle relative to the vehicle frame. Specifically, such forces operate to alter the vertical, lateral, and/or longitudinal position of the axle in relation to the vehicle frame, and also can cause axle movement such as roll, yaw, and wind-up.

A typical axle/suspension system usually limits the six possible axle motions by incorporating into the suspension assembly, which supports the axle, a number of components that react to and control the various forces. Although such conventional suspension assemblies generally serve their intended function, the number and/or type of components in a typical prior art assembly also contribute unwanted complexity, weight and cost to the suspension assembly.

These problems are lessened to a significant degree by the proposals to be found in U.S. Pat. No. 6,527,286 where there is a reduction of the number and/or complexity of parts needed to control the forces imposed on the axle, and specifically by replacing the pair of beams of a typical prior art suspension assembly with a fabricated “torque box”. Depending on the prior art suspension assembly being compared, the present invention incorporating the torque box concept either reduces the number and complexity of parts to save cost and weight, or reduces complexity alone to achieve the same savings The resulting simplified suspension assembly of the present invention also exhibits design flexibility whereby its suspension characteristics, such as roll rate, for example, can be readily changed for adapting the assembly concept to different types of vehicle requirements.

A primary objective of the present invention is to improve on and extend the field of application of what is disclosed in U.S. Pat. No. 6,527,286.

### SUMMARY OF THE INVENTION

According to the present invention, a vehicle suspension system comprises at least one suspension airbag interposed between a vehicle axle and a vehicle body and a supplementary airbag positioned on a fixed support in the suspension system and extending to a structural member of the suspension system, the arrangement being such that with the suspension airbag inflated and the supplementary airbag deflated, the suspension system operates normally, and with the suspension airbag deflated and the supplementary airbag inflated, the suspension system is lifted with a consequent lifting of the axle, to bring its road wheels clear of the road surface.

The invention commences with the recognition that with vehicles with multi-axle aggregates or bogies (tractor or trailer), it is frequently so that not all of its wheels need to be in ground contact, and when unnecessary wear of the tyres would occur. With vehicles with a multi-axle aggregate or bogie, when running empty or with less than full load, at least one axle and its set of non-driven road wheels can be lifted clear of the road surface in perfect safety, such as for example one axle or two axles of a triple axle aggregate or bogie.

With the type of vehicle suspension where an axle is attached to an A-frame to assist in the maintenance of an axle in its required position, the supplementary airbag can be positioned below the A-frame in close proximity to the axle, and the A-frame pivotally connected to the vehicle frame, so that as the or each airbag of the suspension system is deflated, the supplementary airbag below the A-frame is inflated, causing the axle to lift and bring its road wheels clear of the road surface.

The invention is, however, ideally suited to the suspension system discussed in U.S. Pat. No. 6,527,286.

In accordance with an aspect of the invention of particular significance, a suspension system comprises torque means mounted on and extending between the vehicle structure and an axle, said torque means including a generally box-like structure, at least one suspension airbag located between the vehicle structure and the axle, a support means attached to the vehicle structure and extending below the box-like structure, and a supplementary airbag extending between the support and the box-like structure.

Thus, with a vehicle having a double or triple axle aggregate or bogie, operating conventionally and carrying its load, all wheels on all of the axles are in ground contact. With e.g. the vehicle running empty or with a load significantly less than the maximum permitted load, at least one axle of a multi-axle aggregate or bogie can be raised, by deflating the suspension airbag or bags and inflating the supplementary airbag, to cause the box-like structure to lift and as a consequence cause the said axle or axles to lift, to bring its wheels clear of the road.

### BRIEF DESCRIPTION OF THE DRAWINGS

One embodiment of the invention is illustrated by way of example only in the accompanying drawings in which:

FIG. 1 is a schematic representation of a tractor vehicle of the prior art with twin rear axles;

FIG. 2 shows a part of FIG. 1 to a larger scale, with parts removed for clarity;

FIG. 3 is a perspective view of a support member for a supplementary airbag;

FIG. 4 is an underneath plan view of FIG. 3;

FIG. 5 is a side elevation of FIG. 3;

FIG. 6 is a perspective view of the torque box of the vehicle suspension system;

FIG. 7 is an underneath plan view of FIG. 5; and

FIG. 8 shows the assembly of the torque box and supplementary airbag of one embodiment of the invention.

### DETAILED DESCRIPTION OF THE ILLUSTRATED EMBODIMENTS

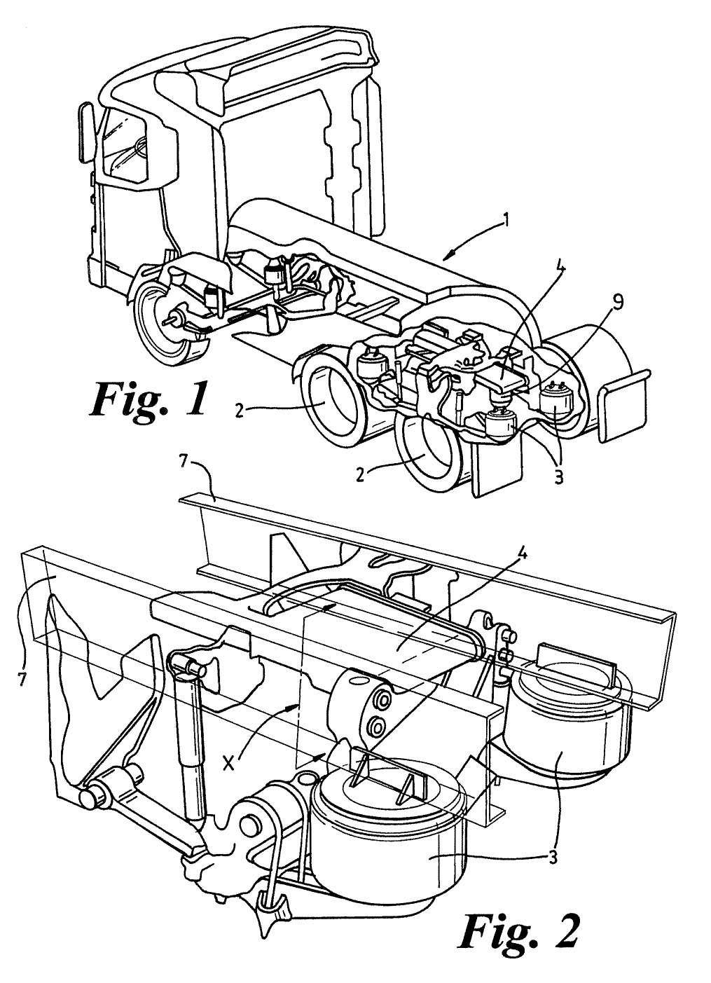

FIG. 1 is a schematic representation of a tractor vehicle 1 with twin rear axles 2, one of which is a driven axle 2 and the other of which is non-driven. As is shown more particularly by FIG. 2, the suspension system is of the type discussed in U.S. Pat. No. 6,527,286, where an axle 2 has airbags 3 forming part of the suspension system, with a torque box 4 also forming part of the suspension system.

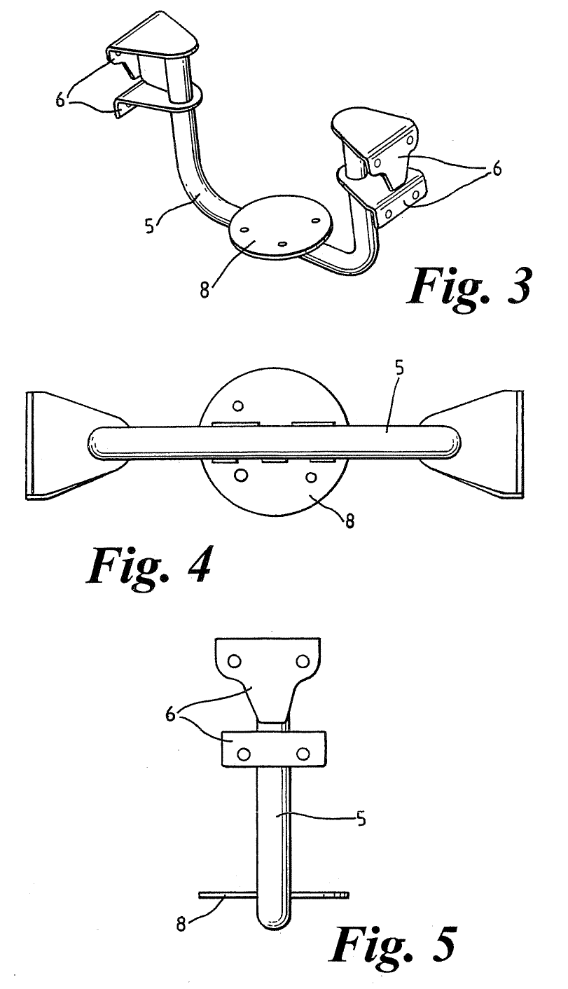

In accordance with one embodiment of the invention, at location X indicated in FIG. 2, a support member 5 as shown in FIGS. 3 to 5 is secured by its flanges 6 to the frame members 7 of the tractor vehicle The support member has a mounting plate 8 for a supplementary airbag 9.

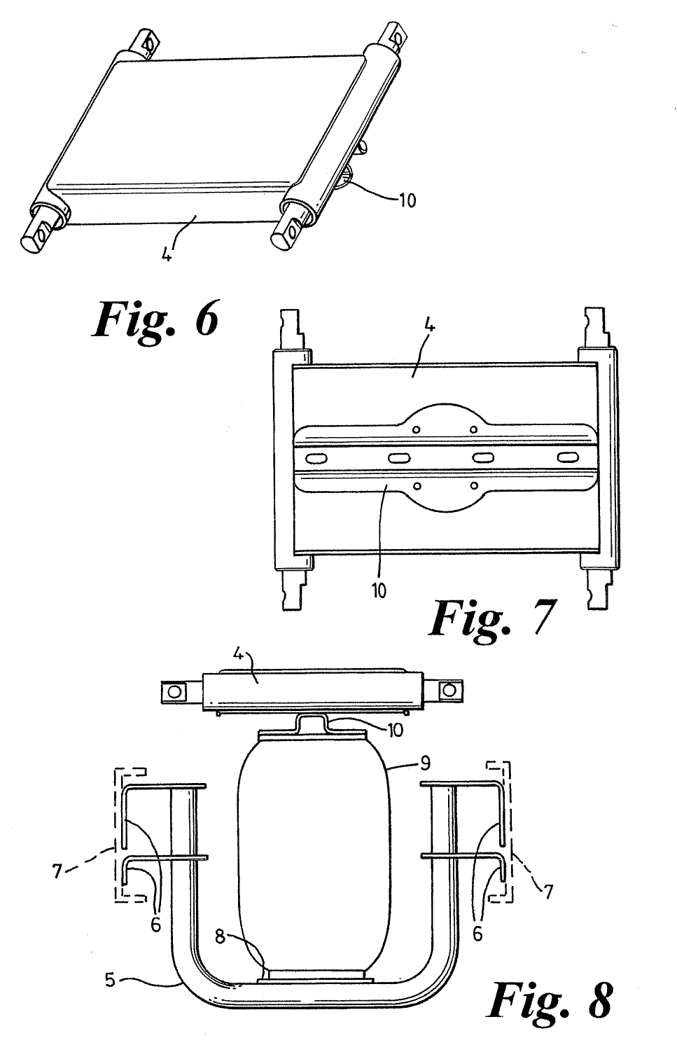

As is shown by FIGS. 6 and 7, the torque box 4 is provided on its underside with a mounting frame 10 to which a supplementary airbag can be attached.

Thus, and as is illustrated in FIG. 8, the supplementary airbag 9 is attached by one end to the mounting plate 8 on the support member 5, and by it other end to the mounting frame 10 on the torque box 4.

With this assembly attached to the vehicle frame members 7 at the location indicated at X in FIG. 2, the supplementary airbag when inflated causes the torque box 4 to lift, and as a consequence causes the axle to which the torque box is connected to lift.

When running normally and laden, the supplementary airbag 9 is deflated and the airbags 3 of the vehicle suspension inflated, and when all four road wheels are in ground contact. When partly laden, or running empty or with the tractor vehicle disconnected from the trailer, the airbags 3 of one non-driven axle 2 can be deflated, with inflation of the supplementary airbag 9, to cause the road wheels of the non-driven axle to be lifted clear of the road.

What is claimed is:

1. A vehicle suspension system comprising at least one suspension airbag interposed between a vehicle axle and a vehicle body and a supplementary airbag positioned on a fixed support in the suspension system and extending to a structural member of the suspension system, the arrangement being such that with the suspension airbag inflated and the supplementary airbag deflated, the suspension system operates normally, and with the suspension airbag deflated and the supplementary airbag inflated, the suspension system is lifted with a consequent lifting of the axle, to bring its road wheels clear of the road surface.

2. A vehicle suspension as in claim 1, wherein the structural member is a torque box having a mounting frame.

3. A vehicle suspension system as in claim 1, wherein an axle is attached to an A-frame to assist in the maintenance of an axle in its required position, and the supplementary airbag is positioned below the A-frame in close proximity to the axle, and the A-frame pivotally connected to the vehicle frame, so that as the or each airbag of the suspension system is deflated, the supplementary airbag below the A-frame is inflated, causing the axle to lift and bring its road wheels clear of the road surface.

4. A vehicle suspension system comprising a torque means mounted on and extending between the vehicle structure and an axle, said torque means including a generally box-like structure, at least one suspension airbag located between the vehicle structure and the axle, a support means attached to the vehicle structure and extending below the box-like structure, and a supplementary airbag extending between the support and the box-like structure, the arrangement being such that with a vehicle having a double or triple axle aggregate or bogie, operating conventionally and carrying its load, all wheels on all of the axles are in ground contact, and with e.g. the vehicle running empty or with a load significantly less than the maximum permitted load, at least one axle of a multi-axle aggregate or bogie can be raised, by deflating the suspension airbag or bags and inflating the supplementary airbag, to cause the box-like structure to lift and as a consequence cause the said axle or axles to lift, to bring its wheels clear of the road.
